(19) United States
(12) Patent Application Publication
(10) Pub. No.: US 2023/0225309 A1
(43) Pub. Date: Jul. 20, 2023

(54) DEVICE FOR THE CRYOGENIC FREEZING OF UNITS FOR PACKAGING A BIOLOGICAL SUBSTANCE

(71) Applicant: IMV TECHNOLOGIES, SAINT OUEN SUR ITON (FR)

(72) Inventors: Eric SCHMITT, VILLAINES-LA-JUHEL (FR); Jean-Charles GORGES, CHENAY (FR); Jean-Louis DOUESNEL, BRETEUIL-SUR-ITON (FR); Thierry LOUVIOT, SAINT SULPICE SUR RISLE (FR)

(21) Appl. No.: 18/007,142

(22) PCT Filed: Jul. 29, 2021
(86) PCT No.: PCT/FR2021/051423

§ 371 Date: Jan. 27, 2023

(30) Foreign Application Priority Data
Jul. 29, 2020 (FR) FR2008011

(51) Int. Cl. A01N 1/02; F25D 3/10; F25D 23/02

(52) U.S. Cl. CPC A01N 1/0268; F25D 3/10; F25D 23/02; A01N 1/0252

(57) ABSTRACT

The invention relates to a device for cryogenic freezing of units for packaging a biological substance comprising a receptacle (2) configured such that a stream of vapour of a cryogenic agent circulates therein, having at its top an insertion opening (10) for inserting the packaging units into the receptacle (2), a lid (3) that is able to move between a closed position in which it closes the insertion opening (10) and an open position in which it leaves the insertion opening (10) open, and a port (4) for discharging the vapour, provided in the receptacle (2), characterised in that the device (1) further comprises a stopper (13) mechanically connected to the lid (3) such that, when the lid (3) is in the closed position, the stopper (13) is spaced apart from the port (4) and, when the lid (3) is in the open position, the stopper (13) closes the port (4).

### TECHNICAL FIELD OF THE INVENTION

The invention relates to the preservation of units for packaging a biological substance, in particular the cryopreservation of animal semen.

### STATE OF THE ART

It is known that for certain animal species, for example in particular bovine and equine livestock, semen is treated after collection by diluting then the diluted semen is subdivided into packaging units each filling a straw formed by a thin tube of plastic material and by a stopper engaged in that tube, the dose of semen being disposed between the stopper and the end of the tube furthest from the stopper, the corresponding end section being closed off after filling by crushing and welding.

The preservation of the doses of semen contained in the straws is carried out by immersion of the straws in a bath of liquid nitrogen.

Prior to that immersion, the straws are frozen.

Slow freezing (several hours) may be carried out by static suspension of the product to freeze in nitrogen vapor, above a bath of liquid nitrogen.

Fast freezing (a few minutes) may be carried out using a programmable freezer, regulating the supply of cryogenic fluid within a tank promoting heat exchange, by stirring air for example.

In addition to increased productivity, the advantage of fast freezing lies mainly in the reduction of the size of ice crystals, which are detrimental to biological cells.

In practice, to fast-freeze straws a plurality thereof is disposed on a rack referred to as freezing rack then the freezing rack carrying the straws is placed in the freezer. In general, the freezer is dimensioned to receive several freezing racks superposed.

FIG. 1 of the accompanying drawings shows a known freezer comprising a receptacle 2, a lid 3 and an aperture 4. The stream of liquid nitrogen vapor flows in the receptacle 2 within which are disposed products 11 which here are straws on freezing racks.

The lid 3 is hinged to the receptacle 2 such that the freezer is able to adopt a closed position, shown in FIG. 1, or an open position making it possible to introduce the products 11 into the receptacle or to retrieve them. The aperture 4 is provided in the receptacle 2 for the venting of the gas, as shown by the arrow 17 in FIG. 1, in order to avoid any excess pressure within the receptacle 2 of the freezer when it is in closed position.

### DISCLOSURE OF THE INVENTION

The invention is directed to providing a freezing device which, simply, conveniently and economically, limits the temperature rise within the receptacle when the lid is in open position.

To that end, the invention provides a device for the cryogenic freezing of units for packaging a biological substance, comprising:
a receptacle configured in order for a stream of vapor of a cryogenic agent to flow therein, having at its top an opening for introduction of said packaging units into said receptacle;
a lid movable between a closed position in which it closes said introduction opening and an open position in which it leaves said introduction opening free; and
an aperture for venting said vapor, provided in said receptacle;
characterized in that said device further comprises an obturator mechanically connected to said lid such that when said lid is in closed position, said obturator is away from said aperture and when said lid is in open position, said obturator closes said aperture.

The invention is based on the observation that when the freezer is in open position, the ambient air, in contact with the nitrogen vapor, cools, contracts and enters the freezer then exits through the vapor venting aperture or venting apertures if there are several of them; and that it is primarily this flow of air that induces a gradual rise in the temperature within the receptacle of the freezer, from which results in particular a rise in the temperature of the biological substance contained in the packaging units closest to the lid.

To limit the temperature rise in the receptacle when the lid of the freezing device is in open position, the device according to the invention provides an obturator of the aperture linked to the lid to allow a position in which it closes the aperture when the lid is in open position.

Such an obturator, on account of its link to the lid, enables the aperture to be left free when the lid is in closed position and thus avoid any excess pressure in the receptacle, and to limit the introduction of ambient air into the receptacle in open position, the closing of the aperture (or apertures if there are several of them) prevents the ambient air from descending into the receptacle and flowing therein until it leaves by the venting aperture.

On account of its direct link with the lid, the obturator does not require a dedicated actuator.

Moreover, the risk of the system jamming by accumulation of frost is non-existent.

Advantageous features that are particularly simple, convenient and economical of the device for cryogenic freezing of units for packaging a biological substance according to the invention are presented below:
said obturator is mechanically connected to an edge of said lid;
said receptacle comprises a bottom wall and four lateral walls, respectively a first lateral wall, a second lateral wall, a third lateral wall and a fourth lateral wall, the first lateral wall being opposite the third lateral wall, the second lateral wall being opposite the fourth lateral wall, the first lateral wall and the third lateral wall connecting together the second lateral wall and the fourth lateral wall, each of the lateral walls projecting from said bottom wall and extending to said introduction opening, said aperture being provided in one of said lateral walls;
said lid is linked to one of the lateral walls of said receptacle by means of an articulation member forming a hinge around which the lid pivots so as to be movable between its open position and its closed position, said lid being connected to the lateral wall in which is provided said aperture;
said obturator comprises an arm and an obturating plate, the arm projecting from an edge of said lid from a first end to a free second end, the obturating plate being linked to said second end of said arm such that when the lid is in closed position said obturating plate is away from said aperture and when the lid is in open position said obturating plate closes said aperture;
the obturating plate is directly mechanically connected to said second end of the arm;
the obturator further comprises a spring, said spring being mechanically connected to said second end of said arm and furthermore being mechanically connected to said obturating plate;
said obturator comprises an arm and an obturating plate, the arm projecting from an edge of said lid from a first end to a free second end, the obturator pivoting around the articulation member with a path in a circle arc of which the radius is equal to the length of said arm, said aperture being provided at a distance from the top of the receptacle equal to the length of said arm;
the aperture is formed by a tube projecting from the receptacle, said obturating plate bearing on the projecting end of said tube in the open position of the lid; and
the device is configured for the cryogenic freezing of straws containing diluted animal semen.

### BRIEF DESCRIPTION OF THE DRAWINGS

The disclosure of the invention will now be continued with the detailed description of embodiments, given below by way of illustrative and non-limiting examples, with reference to the accompanying drawings. In these:

FIG. 1 is a diagrammatic cross-section view of a freezing device of the prior art in closed position;

FIG. 2 is a diagrammatic cross-section view of a freezing device according to the invention in closed position in which the obturator leaves the aperture free while being away from it;

FIG. 3 is a diagrammatic cross-section view of the freezing device which is similar to FIG. 2 but in open position in which the obturator closes the aperture;

FIG. 4 is an enlargement of the freezing device according to the invention in the position shown in following 2, making the obturator especially visible, and

FIG. 5 is a similar view to FIG. 4, except that the freezing device is in the open position shown in FIG. 3.

### DETAILED DESCRIPTION

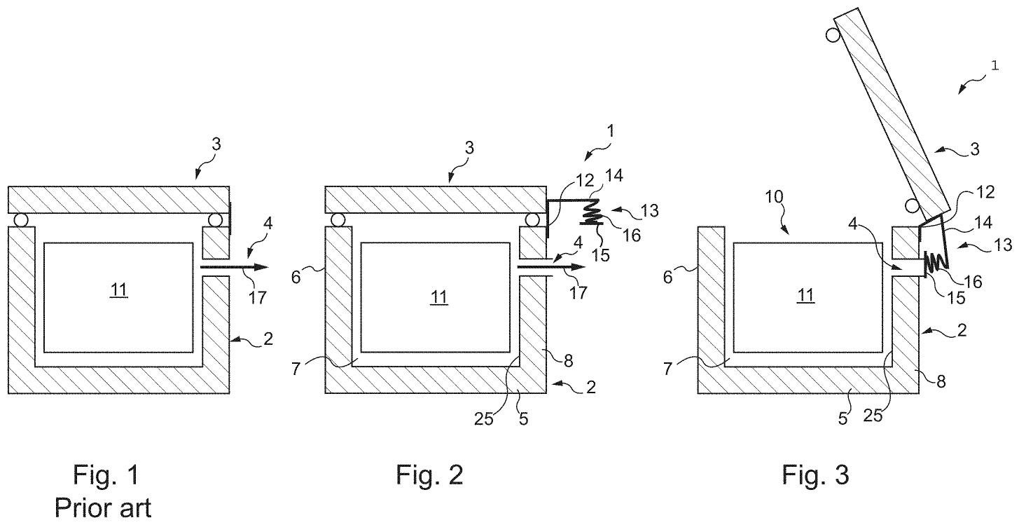

In the interest of simplicity, in the following description, the same numerical references have been use for parts in common between the prior art illustrated in FIG. 1 and the invention illustrated in FIGS. 2 to 5.

The device 1 for cryogenic freezing of units for packaging biological substances, in particular doses of animal semen, illustrated in FIGS. 2 and 3 comprises a receptacle 2, a lid 3 and an aperture 4.

The receptacle 2 is configured in order for a stream of vapor of a cryogenic agent to flow therein, the cryogenic agent here being vapor from liquid nitrogen, in which is plunged a product 11 to freeze such as straws filled with semen disposed on one or more superposed freezing racks.

The receptacle 2 has the general shape of a box of rectangular section, with a bottom wall 5 and four lateral walls, respectively a first lateral wall 6, a second lateral wall 7, a third lateral wall 8 and a fourth lateral wall not visible in the drawings.

The first lateral wall 6 is opposite the third lateral wall 8 and the second lateral wall 7 is opposite the fourth lateral wall. The first lateral wall 6 and the third lateral wall 8 connect together the second lateral wall 7 and the fourth lateral wall.

Each lateral wall projects from the bottom wall 5.

The lateral walls 6, 7, 8, 9 each comprise a free end. The free ends of the lateral walls delimit an introduction opening 10 of the receptacle 2 in its top.

This introduction opening 10 enables the product 11 to be introduced inside the receptacle 2 or removed from the receptacle 2.

The lid 3 is of parallelepiped shape and has the dimensions of the introduction opening 10 of the receptacle 2.

The lid 3 cooperates with the receptacle 2. In particular, the lid 3 is connected to any one of the lateral walls of the receptacle 2 by means of an articulation member 12 forming a hinge.

Here, the lid 3 is linked to the third lateral wall 8.

The aperture 4 is provided in one of the lateral walls of the receptacle and is configured to enable the venting of the vapor (the escaping vapor being represented by the arrow 17 in FIG. 2) in order to avoid any excess pressure inside the receptacle 2 of the device 1.

Furthermore, aperture 4 provided in the lateral wall to which the lid 3 is linked, here the third lateral wall 8.

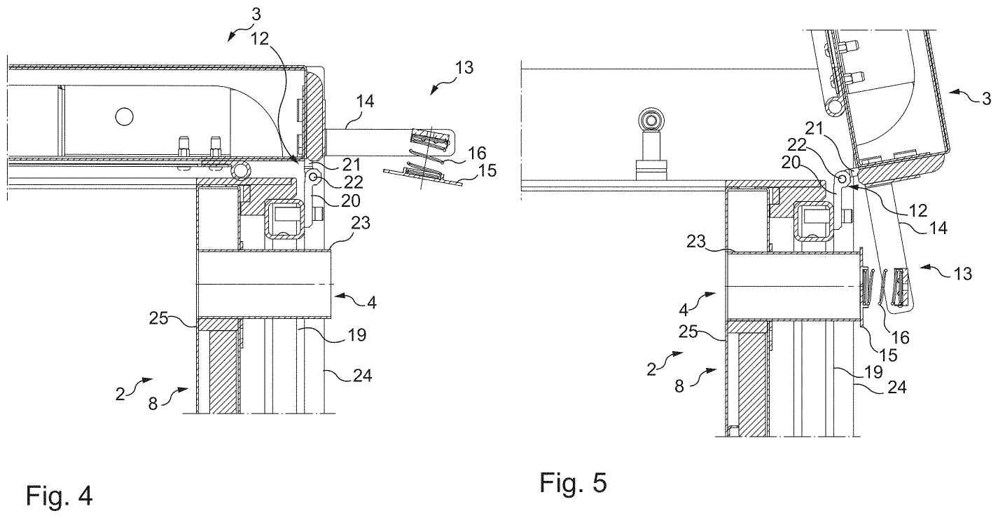

FIGS. 4 and 5 show a cross-section view of the device 1, showing in particular the aperture 4 as well as the articulation member 12 between the lid 3 and the lateral wall.

The lateral wall 8 comprising the aperture 4 is associated with a frame 19 on which is fastened the articulation member 12. The frame 19 is interposed between the lateral wall 8 and an outside wall 24.

The articulation member 12 is configured in order for the lid 3 to be movable between an open position in which it leaves the introduction opening 10 free and a closed position in which it closes the introduction opening 10.

The articulation member 12 is formed by a hinge of which a first fixed member 20 which is fixed relative to the receptacle 2 on opening the lid 3 is fastened to the frame 19 of the receptacle 2, a second movable member 21 which is movable relative to the receptacle 2 on opening the lid 3 is fastened to the edge of the lid 3 and of which a journal 22 disposed between the first fixed member 20 and the second movable member 21 delimits the axis around which the lid 3 pivots.

The lid 3 has a path in a circle arc between its open position and its closed position.

The aperture 4 is delimited by a tube 23 passing through the lateral wall 8, from an inside face 25 of the receptacle 2 at least until an outside face of the outside wall 24.

As can be seen in FIGS. 4 and 5, the tube 23 projects from the outside wall 24.

The device 1 further comprises an obturator 13.

The obturator is mechanically connected to the lid 3 such that when the lid 3 is in closed position, the obturator 13 is away from the aperture 4 (FIGS. 2 and 4) and when the lid 3 is in open position, the obturator 13 closes the aperture 4 (FIGS. 3 and 5).

The obturator 13 is mechanically connected to a lateral edge of the lid 3 and is fixed relative to the lid 3.

The obturator 13 comprises an arm 14, an obturating plate 15 and a spring 16.

The arm 14 projects from the edge of the lid 3 from a first end to a second end which is a free end.

The obturating plate 15 is configured to leave the aperture 4 free when the lid 3 is in closed position and to close the aperture 4 when the lid 3 is in open position.

The obturating plate 15 is linked to the second end of the arm 14.

Here, the spring 16 which is interposed between the arm 14 and the obturating plate 15 is mechanically connected to the second end of the arm 14, and is furthermore mechanically connected to the obturating plate 15.

The obturator 13 pivots around the journal 22 of the articulation member 12 with a path in a circle arc of which the radius is equal to the length of the arm 14.

The path in a circle arc of the obturator 13 is coaxial with the path in a circle arc of the lid 3.

The aperture 4 is provided in the lateral wall 8 at a distance from its free end equal to the length of the arm 14.

In the open position of the lid 3 illustrated in FIGS. 3 and 5, the obturating plate 15 bears on a wall bordering the aperture 4.

Here, the obturating plate 15 bears on the end of the tube 23 projecting from the outside wall 24.

The cooperation of the spring 16 and the obturating plate 15 enables the obturator 13 to press upon the projecting end of the tube 23 whereby the aperture 4 is closed in a manner fluid-tight to gas.

Once the aperture 4 has been closed in fluid-tight manner in open position of the lid 3, the ambient air, initially having a tendency to flow through the aperture 4 since in contact with the nitrogen vapor, it cools and contracts, now remains superficial relative to the receptacle 2.

Thus, the gradual rise in temperature within the receptacle 2 of the device 1 is minimal.

In variants not shown:
the obturating plate is directly mechanically connected to the arm of the obturator;
the device comprises a plurality of vapor venting apertures in the lateral wall and a plurality of obturators 13 cooperating with the plurality of apertures;
the tube forming the aperture does not project from the outside wall and extends to the outside face of the outside wall, the obturating plate bearing against the portion of outside wall bordering the aperture;
the aperture is delimited other than by a tube, for example by a hole provided in a solid wall;
the obturator slides rather than pivots, for example if the venting aperture is in fluidic communication with an extractor; and/or
the packaging straws disposed on freezing racks are replaced by other units for packaging a biological substance, for example a tube for packaging embryos or blood.

Numerous other variants are possible according to circumstances, and in this connection it is to be noted that the invention is not limited to the examples described and shown.

1. A device for the cryogenic freezing of units for packaging a biological substance, comprising:
a receptacle configured in order for a stream of vapor of a cryogenic agent to flow therein, having at its top an opening for introduction of said packaging units into said receptacle;
a lid movable between a closed position in which it closes said introduction opening and an open position in which it leaves said introduction opening free; and
an aperture for venting said vapor, provided in said receptacle; and
an obturator mechanically connected to said lid such that when said lid is in closed position, said obturator is away from said aperture and when said lid is in open position, said obturator closes said aperture.

2. The device according to claim 1, wherein said obturator is mechanically connected to an edge of said lid.

3. The device according to claim 1, wherein said receptacle comprises a bottom wall and four lateral walls, respectively a first lateral wall, a second lateral wall, a third lateral wall and a fourth lateral wall, the first lateral wall being opposite the third lateral wall, the second lateral wall being opposite the fourth lateral wall, the first lateral wall and the third lateral wall connecting together the second lateral wall and the fourth lateral wall, each of the lateral walls projecting from said bottom wall and extending to said introduction opening, said aperture being provided in one of said lateral walls.

4. The device according to claim 3, wherein said lid is linked to one of the lateral walls of said receptacle by means of an articulation member forming a hinge around which the lid pivots so as to be movable between its open position and its closed position, said lid being connected to the lateral wall in which is provided said aperture.

5. The device according to claim 1, wherein said obturator comprises an arm an obturating plate, the arm projecting from an edge of said lid from a first end to a free second end, the obturating plate being linked to said second end of said arm such that when the lid is in closed position said obturating plate is away from said aperture and when the lid is in open position said obturating plate closes said aperture.

6. The device according to claim 5, wherein the obturating plate is directly mechanically connected to said second end of the arm.

7. The device according to claim 5, wherein the obturator further comprises a spring, said spring being mechanically connected to said second end of said arm and furthermore being mechanically connected to said obturating plate.

8. The device according to claim 4, wherein said obturator comprises an arm and an obturating plate, the arm projecting from an edge of said lid from a first end to a free second end, the obturator pivoting around the articulation member with a path in a circle arc of which the radius is equal to the length of said arm, said aperture being provided at a distance from the top of the receptacle equal to the length of said arm.

9. The device according to claim 5, wherein the aperture is formed by a tube projecting from the receptacle, said obturating plate bearing on the projecting end of said tube in the open position of the lid.

10. The device according to claim 1, wherein the device is configured for the cryogenic freezing of straws containing diluted animal semen.
